(19) United States
(12) Patent Application Publication
(10) Pub. No.: US 2015/0241692 A1
(43) Pub. Date: Aug. 27, 2015

(54) PROJECTION LENS ASSEMBLY AND PROJECTION APPARATUS USING THE SAME

(71) Applicants: Qisda Optronics (Suzhou) Co., Ltd., Suzhou (CN); Qisda Corporation, Taoyuan (TW)

(72) Inventor: MING-KUEN LIN, Taoyuan City (TW)

(21) Appl. No.: 14/620,217

(22) Filed: Feb. 12, 2015

(30) Foreign Application Priority Data
Feb. 21, 2014 (TW) 103105930

(51) Int. Cl. G02B 27/00; G02B 13/16; G03B 21/28; G02B 13/04

(52) U.S. Cl. CPC G02B 27/0018; G02B 13/04; G02B 13/16; G03B 21/28

(57) ABSTRACT

A projection lens assembly including a first lens group and a second lens group is provided. The first lens group has a negative dioptre and is disposed adjacent to an object side. The first lens group includes a first lens having the negative dioptre. The first lens has a first surface and a second surface opposite to each other. The first surface faces the object side. A curvature radius of the first surface is greater than or equal to 500 mm. The second lens group having a positive dioptre and is disposed adjacent to an image side. The second lens group has a third surface facing the object side. An effective focal length of the projection lens assembly is f, a distance between the second surface and the third surface is d, and a lens amount of the projection lens assembly is n, wherein d/f≧1.6 and 7≧n≧4.

### FIELD OF THE INVENTION

The present invention relates to projection lens assembly and projection apparatus using the same, and more particularly to a projection lens assembly and a projection apparatus using the same that are able to avoid the ghost images and light leakage.

### BACKGROUND OF THE INVENTION

In order to improve the image brightness, the conventional projector/projection apparatus is designed to have increased contrast ratio. However, the increased contrast ratio may cause the projection lens assembly to generate ghost image or light leakage on the screen. Please refer to FIG. 4, which is a schematic diagram of a conventional projection apparatus. As shown in FIG. 4, the conventional projection apparatus 50 includes an imaging unit 42 and a projection lens assembly 40. The imaging unit 42 is for providing lights with image and the projection lens assembly 40 is for projecting the lights onto a screen (not shown). The projection lens assembly 40 includes a first lens group 44 with negative dioptre and a second lens group 46 with positive dioptre. The first lens group 44 is disposed adjacent to the screen (or, an object side, not shown) and the second lens group 46 is disposed adjacent to an image side (not shown) towards the imaging unit 42. The first lens group 44 includes at least one meniscus lens 48 having the negative dioptre. The meniscus lens 48 has a first surface s1 and a second surface s2 opposite to each other; wherein the first surface s1 is a convex surface and the second surface s2 is a concave surface. Both of the first and second surface s1, s2 have a curvature radius about 100˜200 mm. As shown, because both of the first and second surface s1, s2 are cambered and the incident angle of the light emitting into the meniscus lens 48 from the second lens group 46 is substantially equal to the normal vector of the first surface s1, thus, the light emitting onto the first surface s1 from the second surface s2 may be reflected back to the second lens group 46 and the imaging unit 42 (e.g., a digital micromirror device (DMD) or a liquid crystal display (LCD) panel) along the original incident light path. And consequentially, the ghost image (e.g., the light spot or light ring) may occur when the light, emitting onto the first surface s1 has multiple reflections between the first and second surface s1, s2. Please refer to FIG. 5, which is a schematic diagram illustrating a ghost image/light leakage projected on a screen by a conventional projection lens assembly 40. As shown in FIG. 5, a ghost image having the outline of the imaging unit 46 (in the case when the conventional projection apparatus 50 is a digital light processing (DLP) projection apparatus) or an unexpected luminance (in the case when the conventional projection apparatus 50 is a liquid crystal projection apparatus) is formed in the image projected on the screen. Because the ghost image or the unexpected luminance may affect the quality of the displayed image on the screen, it is quite important to design a projection lens assembly able to avoid the ghost image or unexpected luminance issue in the related optical industry.

### SUMMARY OF THE INVENTION

Therefore, one object of the present invention is to provide a projection lens assembly and a related projection apparatus able to overcome the aforementioned issues.

The present invention provides a projection lens assembly, which includes a first lens group and a second lens group. The first lens group has a negative dioptre and is disposed adjacent to an object side. The first lens group includes a first lens having the negative dioptre. The first lens has a first surface and a second surface opposite to each other. The first surface faces the object side. A curvature radius of the first surface is greater than or equal to 500 mm. The second lens group having a positive dioptre and is disposed adjacent to an image side. The second lens group has a third surface facing the object side. An effective focal length of the projection lens assembly is f, a distance between the second surface and the third surface is d, and a lens amount of the projection lens assembly is n, wherein d/f≧1.6 and 7≧n≧4.

The present invention further provides a projection apparatus for projecting an image onto a screen. The projection apparatus includes a light source, an imaging unit and a projection lens assembly. The light source is for providing a light. The imaging unit is for receiving the light. The projection lens assembly is disposed between the imaging unit and the screen and for projecting the light onto the screen. The projection lens assembly includes a first lens group and a second lens group. The first lens group has a negative dioptre and is disposed adjacent to the screen. The first lens group includes a first lens having the negative dioptre. The first lens has a first surface and a second surface. The first surface faces the screen. A curvature radius of the first surface is greater than or equal to 500 mm. The second lens group has a positive dioptre and is disposed adjacent to the image unit. The second lens group has a third surface facing the screen. An effective focal length of the projection lens assembly is f, a distance between the second surface and the third surface is d, and a lens amount of the projection lens assembly is n, wherein d/f≧1.6 and 7≧n≧4.

In summary, a plano-concave lens which is closest to the screen on the object side is disposed in the first lens group and adjacent to the object side in the present invention. Specifically, the first surface of the plano-concave lens faces the object side and is a flat surface or a surface with a curvature radius greater than or equal to 500 mm. Thus, the plano-concave lens can diverge the light emitting from the second lens group so as to prevent the light from being reflected back to the second lens group and the imaging unit. As a result, the ghost image or unexpected luminance is avoided. In addition, compared with the prior art, the projection lens assembly and the projection apparatus of the present invention can have ghost image/light leakage elimination effect by using less amount of lens and having relatively large distance between two lens groups.

For making the above and other purposes, features and benefits become more readily apparent to those ordinarily skilled in the art, the preferred embodiments and the detailed descriptions with accompanying drawings will be put forward in the following descriptions.

### BRIEF DESCRIPTION OF THE DRAWINGS

The present invention will become more readily apparent to those ordinarily skilled in the art after reviewing the following detailed description and accompanying drawings, in which:

FIG. 1 is a schematic diagram of a projection apparatus in accordance with an embodiment of the present invention;

FIG. 2 is a schematic structural diagram of a part of the projection apparatus of FIG. 1;

FIG. 3 is a schematic diagram illustrating a light path in the projection apparatus of the embodiment of present invention;

FIG. 4 is a schematic structural diagram of a part of a conventional projection apparatus; and

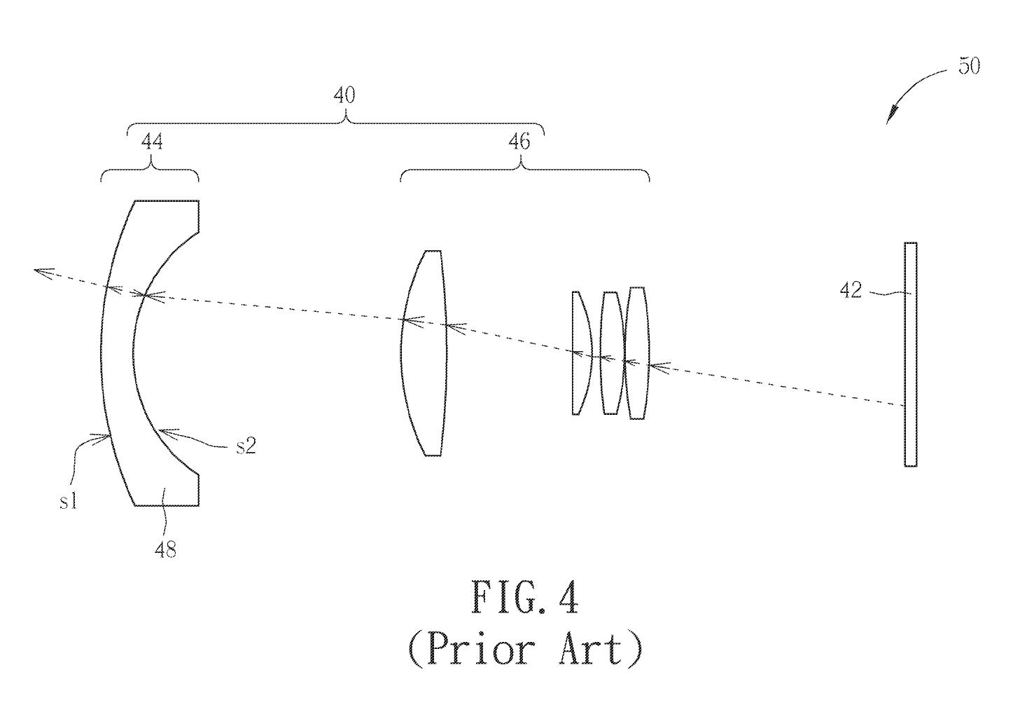

FIG. 5 is a schematic diagram illustrating a ghost image/light leakage projected on a screen by a conventional projection lens assembly.

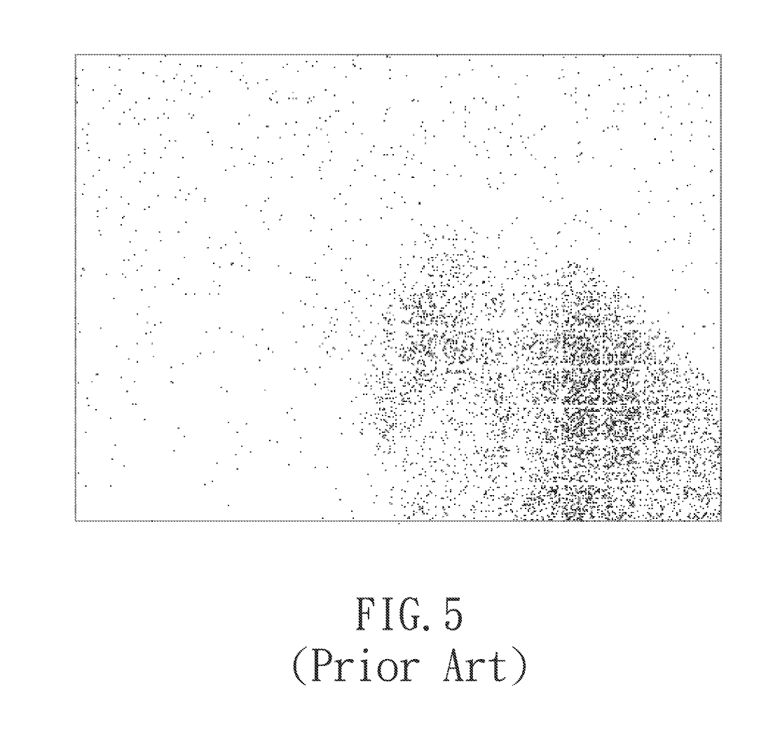

### DETAILED DESCRIPTION OF PREFERRED EMBODIMENTS

The present invention will now be described more specifically with reference to the following embodiments. It is to be noted that the following descriptions of preferred embodiments of this invention are presented herein for purpose of illustration and description only. It is not intended to be exhaustive or to be limited to the precise form disclosed.

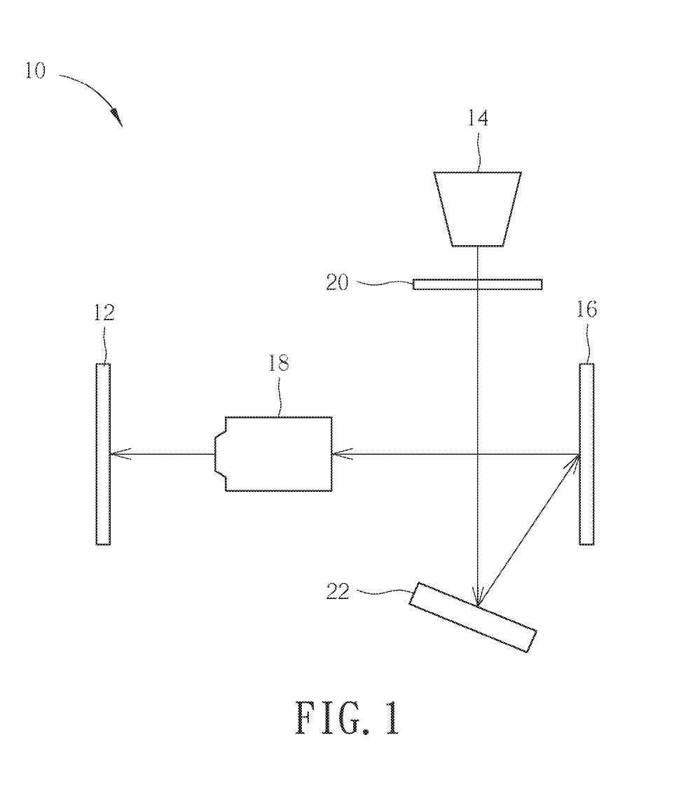

FIG. 1 is a schematic diagram of a projection apparatus in accordance with an embodiment of the present invention. As shown in FIG. 1, the projection apparatus 10 in the present embodiment is for projecting images onto a screen 12 and includes a light source 14, an imaging unit 16, a projection lens assembly 18, a light filter unit 20 and a reflective element 22. Specifically, the light source 14 is for outputting light. The light filter unit 20 is for receiving the light from the light source 14 and filtering the light into a plurality of color lights. The reflective element 22 is for reflecting the plurality of color lights from the light filter unit 20 to the imaging unit 16. The imaging unit 16 is for receiving the plurality of color lights reflected by the reflective element 22 and transmitting the color lights to the projection lens assembly 18. The projection lens assembly 18, disposed between the imaging unit 16 and the screen 12, is for projecting the color lights from the imaging unit 16 onto the screen 12. In the case when the projection apparatus 10 is a digital light processing (DLP) projection apparatus, the light filter unit 20 is a color wheel, the imaging unit 16 is a digital micromirror device (DMD) and the reflective element 22 is a concave mirror. In the case when the projection apparatus 10 is a liquid crystal projection apparatus, the light filter unit 20 is a filter film, the reflective element 22 is a mirror and the imaging unit 16 is a liquid crystal display (LCD) panel.

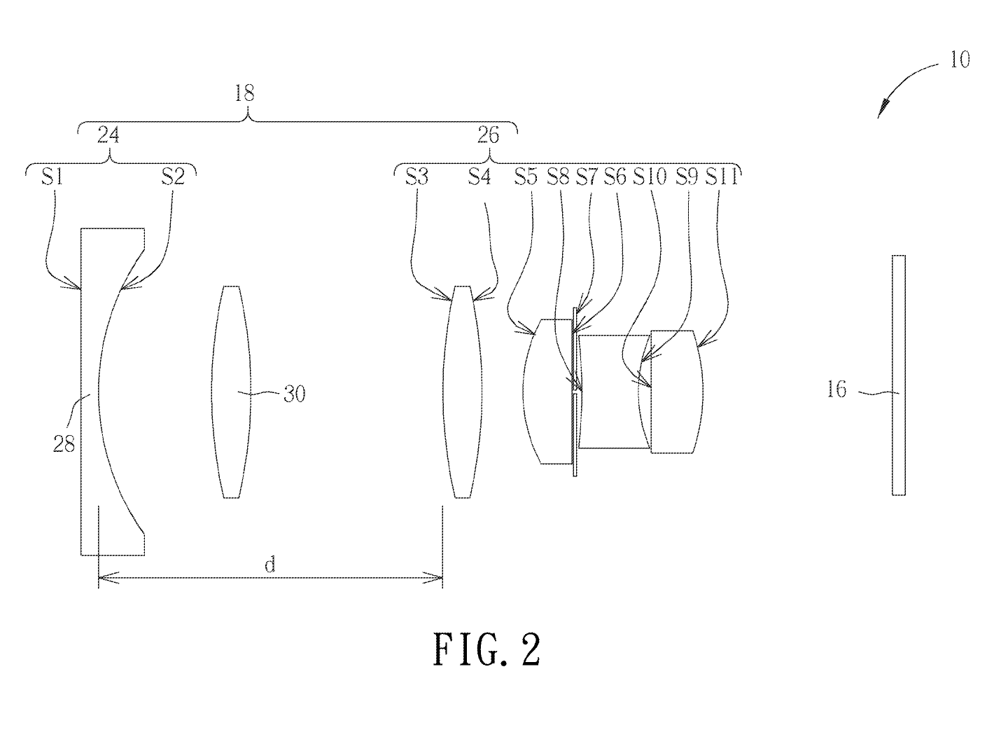

Please refer to FIG. 2, which is a schematic structural diagram of a part of the projection apparatus 10 of FIG. 1. As shown in FIG. 2, the projection lens assembly 18 includes a first lens group 24 and a second lens group 26. The first lens group 24 is disposed adjacent to the screen 12 (i.e., an object side, FIG. 1) and the second lens group 26 is disposed adjacent to the imaging unit 16 (i.e., an image side). The first lens group 24 has a negative dioptre and is used to diverge light. The second lens group 26 has a positive dioptre and is used to converge light. The first lens group 24 includes a first lens 28 having a negative dioptre. The first lens 28 has a first surface S1 and a second surface S2 opposite to each other. Specifically, the first surface S1 faces the screen 12 and the second surface S2 faces the second lens group 26. In one preferred embodiment, the first surface S1 is a flat surface having an infinity curvature radius; and correspondingly, the first lens 28 is a plano-concave lens. In another preferred embodiment, the first surface S1 is a surface with no obvious radian and having a curvature radius greater than or equal to 500 mm; and correspondingly, the first lens 28 closely approximates a plano-concave lens.

As shown in FIG. 2, the first lens group 24 may selectively include at least one second lens 30. The second lens 30 is disposed between the first lens 28 and the second lens group 26; in other words, the first lens 28 is disposed on the object side of the first lens group 24 and the second lens 30 is disposed on the image side of the first lens group 24. The dioptre of the second lens 30 is not limited in the present invention; that is, the second lens 30 may have either positive dioptre or negative dioptre depending on the design requirement. In the first lens group 24, it is to be noted that the first lens 28 is always disposed closest to the screen 12 regardless of whether the first lens group 24 includes the second lens 30 or not. By using the first lens 28 (a plano-concave lens) to diverge the light emitted onto the first surface S1 from the second lens group 26, the light emitting from the second lens group 26 is prevented from being directly reflected back to the second lens group 26 along the incident light path; thus, the ghost image or the unexpected luminance caused by the reflected light is avoided.

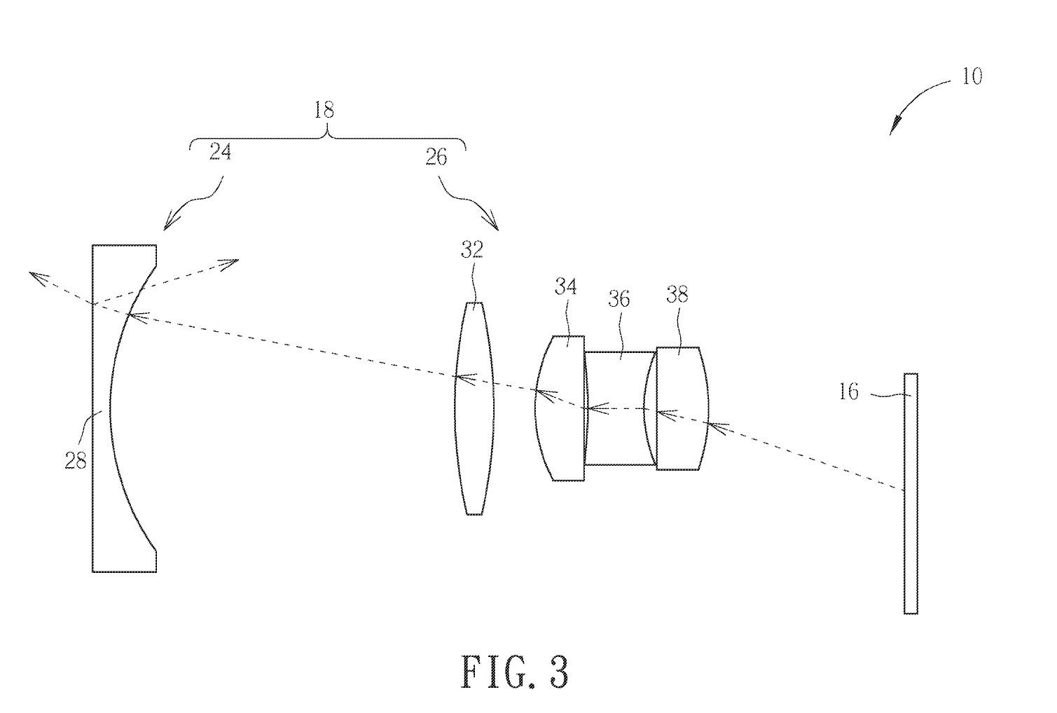

FIG. 3 is a schematic diagram illustrating a light path in the projection apparatus 10; wherein it is to be noted that the second lens 30 is omitted in the first lens group 24 in FIG. 3. Because the functions and structures of the components having the same labeling numbers in FIGS. 2 and 3 have been described above, no redundant detail is to be given herein. As shown in FIGS. 1, 2 and 3, after being sequentially transmitted by the light filter unit 20 and the reflective element 22, the light outputted from the light source 14 emits onto the imaging unit 16. Then, the light passes though the second lens group 26 and emits to the first lens 28 of the first lens group 24. Because the first surface S1 of the first lens 28 is or closely approximates to a flat surface, the light emitting onto the first surface S1 from the second lens group 26 has increased incident angle comparing with the prior art. As a result, the light emitting onto the first surface S1 is prevented from being reflected back to the second lens group 26 and the imaging unit 16 along the original incident light path and is directed to travel in a direction far away from the second lens group 26. In summary, compared with the conventional projection lens assembly 40, the projection lens assembly 18 of the embodiment of the present invention can prevent the light emitting onto the first surface S1 from being reflected back along the original incident light path due to the adopting of the first lens 28 (a plano-concave lens). Specifically, in one particular embodiment of present invention, the projection apparatus 10 is a DLP projection apparatus, the light emitting onto the first surface S1 is prevented from being reflected along the incident light path and emitting onto the Off-mode imaging unit 16 (e.g., a DMD); and consequentially, the ghost image (such as light spot or light ring) is avoided. Or, in an alternative embodiment, the projection apparatus 10 is a liquid crystal projection apparatus, the light emitting onto the first surface S1 is prevented from being reflected along the incident light path and emitting onto the imaging unit 16 (e.g., a liquid crystal display); and consequentially, the unexpected luminance is avoided.

In a conventional projection lens assembly, it is understood that the probability of the appearance of ghost image or unexpected luminance increases with the fewer lens amount (the amount/number of lens in the projection lens assembly) or increases with the distance between two lens groups. However, in the present invention, because the first surface S1 of the first lens 28 is or closely approximates to a flat surface, the amount of light reflected back to the second lens group 26 from the first lens group 24 is reduced; consequentially, the projection lens assembly 18 in the present invention can have improved ghost image/light leakage elimination effect by using less amount/number of lens. In one configuration of the projection lens assembly 18, the lens amount/quantity of the projection lens assembly 18 is n and 7≧n≧4. In another configuration of the second lens group 26 having a third surface S3 facing the screen 12 as shown in FIG. 2, an effective focal length of the projection lens assembly 18 is f, a distance between the second surface S2 and the third surface S3 is d, and d/f≧1.6. By being implemented with the aforementioned configurations, the projection lens assembly 18 of the present invention is facilitated to have improved ghost image/light leakage elimination effect even when the first lens group 24 and the second lens group 26 are disposed relatively far away from each other.

A plurality of preferred parameters of the lenses in the projection apparatus 10 of FIG. 3 are exemplarily provided in the following Table 1. In Table 1, the “distance” herein refers to the interval between the surface in the current row and the surface in the next adjacent row in the Table 1. For example, in one embodiment that the effective focal length f of the projection lens assembly 18 is 21.9 mm, the distance d between the second surface S2 and the third surface S3 is 37.17013 mm; wherein the aforementioned parameter values satisfy the equation d/f≧1.6. It is to be noted that the aforementioned parameter values provided in Table 1 are used for an exemplary purpose only, and the present invention is not limited there to.

TABLE 1

| | | | | | Effective |
|---|---|---|---|---|---|
| | | Curvature | Distance | Refractive | focal length |
| Lens | Surface | radius | (mm) | index | (mm) |
| 28 | S1 | Infinity | 1.8 | 1.49 | −51.290947 |
| | S2 | 25.08 | 37.17013 | | |
| 32 | S3 | 53.95 | 3.68 | 1.72 | 37.997968 |
| | S4 | −53.95 | 4.329724 | | |
| 34 | S5 | 16.1 | 5.16 | 1.62 | 27.056117 |
| | S6 | 350 | 0.2 | | |
| aperture | S7 | Infinity | 0.4619118 | | |
| 36 | S8 | −50 | 6.3 | 1.76 | −13.536167 |
| | S9 | 13.68 | 1.384254 | | |
| 38 | S10 | −198.8 | 5.45 | 1.71 | 27.101234 |
| | S11 | −17.877 | 20.046 | | |

In one preferred embodiment, the projection lens assembly 18 is a non-telemetric system. Specifically, the focal length of the first lens group 24 in the non-telemetric-system projection lens assembly 18 is f1 and

$$1.5 \leq \frac{\vert f 1 \vert}{f} \leq 3.5 .$$

In one preferred embodiment, the effective focal length f of the projection lens assembly 18 is 21.9 mm and the focal length f1 of the first lens group 24 is −51.29 mm, as shown in Table 2. In the present invention, it is to be noted that

$$\frac{\vert f 1 \vert}{f}$$

is required to be modulated within the aforementioned range. For example, if

$$\frac{\vert f 1 \vert}{f}$$

is lower than a lower limit, then |f1| is relatively small and the first lens group 24 has a relatively high dioptre; as a result, the aberration issue may happen. In addition, if

$$\frac{\vert f 1 \vert}{f}$$

is relatively small, then the projection lens assembly 18 includes more lenses and the light is hardly reflected back to the imaging unit 16 along the incident light path, which is not the issue the first lens 28 (a plano-concave lens) in the present invention applies for. Alternatively, if

$$\frac{\vert f 1 \vert}{f}$$

is higher than an upper limit, then |f1| is relatively large and the first lens group 24 has a relatively low dioptre; as a result, the projection lens assembly 18 may have a relatively low magnification, which may not meet the needs or demand from user.

TABLE 2

| f (mm) | f1 (mm) |
|---|---|
| 21.9 | −51.290947 |

In a conventional projection lens assembly, because the lens disposed adjacent to the object side is a meniscus lens, a ghost image having the outline of the relating imaging unit (when the relating projection apparatus is a digital optical projection apparatus) or an unexpected luminance (when the relating projection apparatus is a liquid crystal display (LCD) panel) may occur on a screen. In the present invention, because the first lens 28, provided in the first lens group 24 and disposed closest to the screen on the object side, is a plano-concave lens, the ghost image or the unexpected luminance is effectively eliminated. In other words, not any ghost image having the outline of the imaging unit 16 will be formed and not any unexpected luminance will occur in the image projected on the screen 12 by the projection lens assembly 18.

In one embodiment, the second lens group 26 may selectively include a plurality of lenses, such as the third lens 32, fourth lens 34, the fifth lens 36 and the sixth lens 38, as shown in FIG. 3. Specifically, each of the third lens 32, the fourth lens 34 and the sixth lens 38 has a positive dioptre, and the fifth lens 36 has a negative dioptre. It is to be noted the aforementioned amount/number and the dioptre characteristics of the lenses in the second lens group 26 are provided for an exemplary purpose only, and the present invention is not limited thereto.

In summary, a plano-concave lens is disposed in the first lens group and adjacent to the object side in the present invention. Specifically, the first surface of the plano-concave lens faces the object side and is a flat surface or a surface with a curvature radius greater than or equal to 500 mm. Thus, the plano-concave lens can diverge the light emitting from the second lens group so as to prevent the light from being reflected back to the second lens group and the imaging unit. As a result, the ghost image or unexpected luminance is avoided. In addition, compared with the prior art, the projection lens assembly and the projection apparatus of the present invention can have ghost image/light leakage elimination effect by using less amount of lens and having relatively large distance between two lens groups.

While the invention has been described in terms of what is presently considered to be the most practical and preferred embodiments, it is to be understood that the invention needs not be limited to the disclosed embodiment. On the contrary, it is intended to cover various modifications and similar arrangements included within the spirit and scope of the appended claims which are to be accorded with the broadest interpretation so as to encompass all such modifications and similar structures.

What is claimed is:

1. A projection lens assembly, comprising:
a first lens group, having a negative dioptre and disposed adjacent to an object side, wherein the first lens group comprises a first lens having the negative dioptre, the first lens has a first surface and a second surface opposite to each other, the first surface faces the object side, and a curvature radius of the first surface is greater than or equal to 500 mm; and
a second lens group, having a positive dioptre and disposed adjacent to an image side, wherein the second lens group has a third surface facing the object side,
wherein an effective focal length of the projection lens assembly is f, a distance between the second surface of the first lens and the third surface of the second lens group is d, and a lens amount of the projection lens assembly is n, wherein d/f≧1.6 and 7≧n≧4.

2. The projection lens assembly according to claim 1, wherein a focal length of the first lens group is f1 and
$$1.5 \leq \frac{\vert f 1 \vert}{f} \leq 3.5 .$$

3. The projection lens assembly according to claim 1, wherein a curvature radius of the first surface is infinity and the first lens is a plano-concave lens.

4. The projection lens assembly according to claim 1, wherein the first lens group further comprises at least a second lens disposed between the first lens and the second lens group.

5. The projection lens assembly according to claim 1, wherein the projection lens assembly is a non-telemetric system.

6. A projection apparatus for projecting an image onto a screen, the projection apparatus comprising:
a light source, for providing a light;
an imaging unit, for receiving the light; and
a projection lens assembly, disposed between the imaging unit and the screen and for projecting the light onto the screen, the projection lens assembly comprising:
a first lens group, having a negative dioptre and disposed adjacent to the screen, wherein the first lens group comprises a first lens having the negative dioptre, the first lens has a first surface and a second surface, the first surface faces the screen, and a curvature radius of the first surface is greater than or equal to 500 mm; and
a second lens group, having a positive dioptre and disposed adjacent to the image unit, wherein the second lens group has a third surface facing the screen,
wherein an effective focal length of the projection lens assembly is f, a distance between the second surface and the third surface is d, and a lens amount of the projection lens assembly is n, wherein d/f≧1.6 and 7≧n≧4.

7. The projection apparatus according to claim 6, wherein a focal length of the first lens group is f1 and
$$1.5 \leq \frac{\vert f 1 \vert}{f} \leq 3.5 .$$

8. The projection apparatus according to claim 6, wherein a curvature radius of the first surface is infinity and the first lens is a plano-concave lens.

9. The projection apparatus according to claim 6, wherein the first lens group further comprises at least a second lens disposed between the first lens and the second lens group.

10. The projection apparatus according to claim 6, further comprising:
a light filter unit, for receiving the light from the light source and filtering the light into a plurality of color lights; and
a reflective element, for reflecting the plurality of color lights,
wherein the plurality of color lights reflected by the reflective element is sequentially received by the imaging unit, transmitted to the projection lens assembly and projected onto the screen.
